(19) United States
(12) Patent Application Publication
(10) Pub. No.: US 2004/0048172 A1
(43) Pub. Date: Mar. 11, 2004

(54) Film which can be inscribed by a laser beam

(76) Inventor: Sven Fischer, Muenchen (DE)

Correspondence Address: NIXON PEABODY, LLP, 401 9TH STREET, NW, SUITE 900, WASINGTON, DC, 20004-2128, US

(21) Appl. No.: 10/398,901

(22) PCT Filed: Oct. 12, 2001
(86) PCT No.: PCT/EP01/11840

(30) Foreign Application Priority Data
Oct. 12, 2000 (DE) 200 17 501.7

(51) Int. Cl. G03C 3/00; B44C 1/00; B42D 15/00

(52) U.S. Cl. 430/15; 430/321; 156/235; 156/234; 156/239; 283/86

(57) ABSTRACT

According to the invention, an ablatable metallic layer (3) is arranged below the translucent protective layer (2) which is dyed throughout. Said metallic layer is connected to the contrastive coloured layer by a transparent connecting layer (9), the coloured layer being applied to a plastic film (10). The plastic film (10) comprises a self-adhesive layer (7) on the lower side thereof, the self-adhesive layer being covered on its lower side by a carrier material (8) which represents part of a continuous strip and which is covered in such a way that it rejects adhesive. If the film laminate has been stamped beforehand into individual labels or the like, said labels can be individually detached from the carrier material (8) and can be stuck on many different objects. Surface areas (11a, 11b, 11c, 11d) of the metallic layer (3) representing letters or symbols can be ablated by means of a laser beam (1a, 1b, 1c, 1d). Said surface areas then appear in a mixed colour resulting from the colour of the contrastive layer (5) by means of the colour filter effect of the protective layer (2). The areas which are not ablated appear in a colour resulting from the colour of the metallisation (3) and the colour filter effect of the protective layer (2).

### DESCRIPTION

The present invention relates to a film that can be inscribed by a laser beam, which has at least one protective layer than is substantially penetrable by a laser beam, on whose underside a medium that is changeable by the laser beam is arranged, whereby the medium that is changeable by the laser beam has an opaque layer that is ablatable by the laser beam and at least one contrastive colored layer that is substantially resistant to the laser beam.

By “inscribing”, it is to be understood that what is meant are graphical symbols and characters of each type. The protective layer can be a plastic film, a protective lacquer layer, or the like, for example.

A film of this type is known from the international disclosure WO98/16397. The medium that is changeable by laser beam of the known film has a contrastive layer with coloration under a metallic layer that is ablatable by means of the laser beam, the metallic layer having a coloration or dye that is different from that of the contrastive layer. By “ablation”, what is to be understood is, therefore, the erosion or destruction of a layer, which thereby loses its opaqueness.

If surface components in the form of letters or graphical symbols are ablated by laser action on the metallic layer, these characters are recognizable in the color or dye of the contrastive layer through the protective layer, while the non-ablated region remains visible in the dye of the metallization. The laser action takes place from the side of the protective layer through the protective film.

Of course, one remains limited with the use of the inscribable film according to the type of the film described in WO09/16397, which relates to the colored appearance, as far as one wishes to justifiably maintain the manufacturing expense: The ablated region appears through the protective layer in the color of the contrastive layer, the non-ablated region in the color of the metallization. With the commonly used metallization, generally black or silver white metallization takes place. Therefore, the possible inkings that are available are white or varicolored inscription with a black background or black or multicolored inscription with a silver white background. Indeed, other colors of metallization are contemplated in principle, however, if the colors available for supply, in particular, when one takes into consideration the price of many “varicolored” metals or their application as a thin layer, one is limited to a minimal number from which to choose. Simple color printing of the protective layer is eliminated in most, since film that can be inscribed by laser is used in a first line there, where one, on the basis of the durability against abrasion or bleaching out, must grant exception to printed films.

The invention, subsequently, is based on the problem of producing a film that can be inscribed with a laser beam, which offers a large choice of colors. To this purpose, the positive qualities of common laser-inscribable films should be retained. This means that with inscription with the laser beam, practically no health endangering and environmentally damaging emissions should be produced, and the prepared, inscribed labels, identification plates, etc., should offer large, imminent protection of the lettering relative to chemical and mechanical specifications, that is, among other considerations, a good durability against wear and bleaching out.

The problem is resolved with a film that can be inscribed by a laser beam, which has at least one protective layer that is substantially penetrable by a laser beam, on whose under side, a medium that is changeable by the laser beam is arranged, which has an opaque layer that is ablatable by the laser beam and at least one contrastive layer that is substantially resistance against the laser beam, whereby at least one of the protective layers to be substantially penetrated by the laser beam is dyed through. Therewith, the color impression of the layer visible through the protective layer is affected by the coloring of the protective layer. For example, the non-ablated part of a silver white metallization appears gold-colored through a yellow, dyed-through protective layer.

In one advantageous further embodiment of the invention, the medium that is changeable by the laser beam has at least one further, opaque layer than is ablatable by the laser beam. In this manner, a translucent, dyed-through layer (that is, a substantially penetrable and substantially transparent layer for the laser beam) is arranged between the layers that are ablatable by the laser beam. This allows realization of also sectionally, multicolored inscribing with one and the same foil, whereby the writing color also can be varied first upon the inscribing process itself, as the case may be, if one removes none, multiple, or all superimposed, associated ablatable layers at a selected point.

It is advantageous if at least one of the opaque layers that is ablatable by the laser beam is predominantly metallic. In this manner, the metallization can be steamed on or sputtered, for example, on translucent film. Preferably, the metallic layers are aluminum layers.

In a further embodiment of the invention, at least one of the ablatable layers contains metal oxide, whereby also non-stoichiometric metal oxides and mixtures of metals and metal oxides can be contained.

In a further embodiment of the present invention, the contrastive layer includes multiple regions of differing colors or dyes.

In a particularly preferred embodiment of the present invention, the medium that is changeable by the laser beam has a self-adhesive layer on its under side, whereby the inscribed film can be mounted in a simple manner on a support surface. Preferably, the film previously is arranged on a carrier course coated with an adhesive, from which the film can be pulled before application on the support surface.

In a further advantageous embodiment, the protective layer is provided on its upper side with an adhesive layer, whereby it is suited for use as a rear glass, for example, in automobile rear windows.

Additional adaptations of the visual operation of the present invention can be achieved, in which one prints or lacquers the protective layer at least partially.

In a particularly preferred embodiment of the present invention, the film has stampings, which subdivides the film into individual surface regions, for example, individual character labels, identification plates, or placards. The surface regions, then, can be detached in an advantageous manner and, for example, mechanically mounted on objects to be designated.

In a further advantageous embodiment of the present invention, the film is mountable onto a support surface and has additional safety stampings, which makes impossible undesired removal of the film from the support without at least a partial destruction of the film.

In a further embodiment of the present invention, the film is subdivided by action of a laser beam into individual, at least partially detachable surface regions.

Next, the invention will be described in more detail with reference to the schematically represented embodiments. The illustrations should explain the layer structure of the inventive embodiments, whereby the dimensions are not reproduced according to scale. The drawings show:

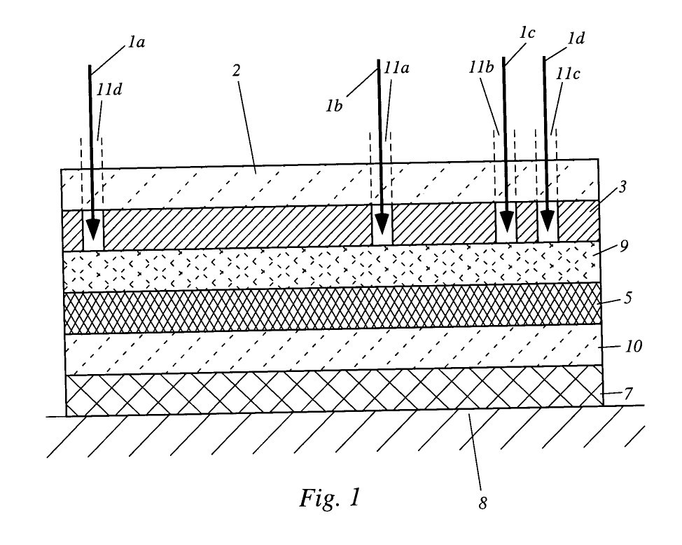

FIG. 1: a schematic sectional representation of the film of the present invention with an ablatable layer;

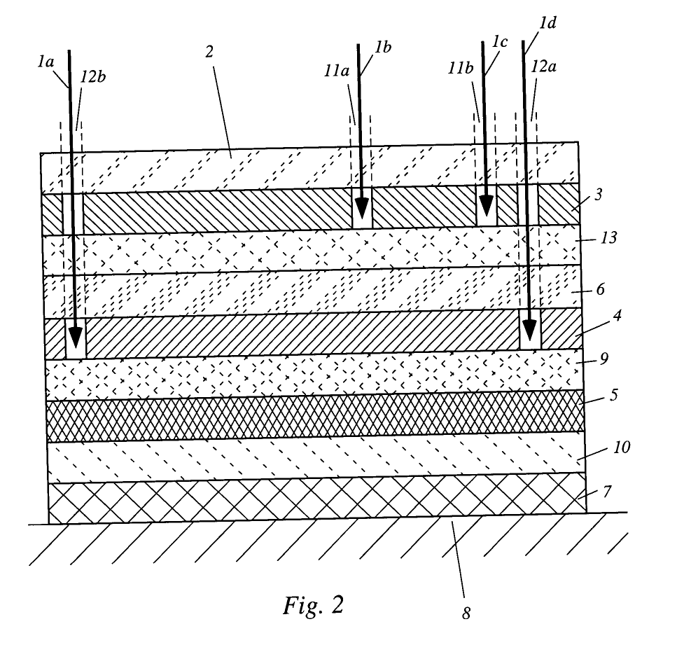

FIG. 2: a schematic sectional representation of a film of the present invention with two ablatable layers.

In FIG. 1, a not-to-scale section perpendicular to the layer structure of an embodiment of the present invention is schematically illustrated. Beneath the translucent, dyed-through protective layer 2, an ablatable, metallic layer 3 is arranged, which is connected with the contrastive colored layer 5 via a transparent connecting layer 9, the contrastive colored layer being mounted on a plastic or synthetic film 10. The protective layer 2, according to its intended purpose, likewise is made of plastic. On its under side, the plastic film 10 has a self-adhesive layer 7, which is covered with a carrier material 8 on the side opposite to the plastic film, the carrier material 8, for example, a part of a carrier material moving through a path or course. The carrier material 8 has an adhesive that is applied through a corresponding treatment, for example, a siliconization, so that the laser-inscribable film can be pulled from the carrier material 8 and can be adhered to a different support surface. If the film laminate is first cut or stamped into individual labels, placards, plates, etc., then these labels, placards, plates, etc., are individually detachable from the carrier material 8 and can be adhered to various objects in a simple manner.

With the assistance of a laser beam 1a, 1b, 1c, 1d, for example, from an electronic, follow-up YAG-laser, surface regions 11a, 11b, 11c, 11c of the metallic layer 3 illustrated with letters or graphical characters can be ablated. This appears, then, in a mixed color, which results from the color-filter effect of the protective layer 2 from the color of the contrastive layer 5.

The non-ablated regions appear in a color, which results from the color of the metallizing 3 with the color-filter action of the protective layer 2. With brighter, adequate coloration of the protective layer 2, the color impression of a darkly colored contrastive layer 5 is only slightly or not at all affected. In the event of a silver white metallization 3, a black contrastive layer 5, and a greenish dyed-through protective layer 2, a black lettering with a green-metallic colored background is provided.

For the case of a silver white metallization 3, a dark blue contrastive layer 5 and a yellow, dyed-through protective layer 2 produces a dark blue lettering with a gold-colored background.

In FIG. 2, a further embodiment of the present invention is represented in a not-to-scale section perpendicular to the layer structure. Beneath the translucent, dyed-through protective layer 2, an ablatable metallic layer 3 is arranged, which is connected with a dyed-through, translucent layer 6 by means of a transparent, isolating layer 13. On the underside of the translucent layer 6, a second ablatable layer 4 is arranged. The dyed-through, translucent layer 6 comprises plastic, and the second ablatable layer 4 is made from metal.

The second ablatable layer 4 is connected with the contrastive colored layer 5 via a transparent connecting layer 9, which is mounted on a plastic film 10. The protective layer 2 is likewise made from plastic. On its underside, the plastic film 10 has a self-adhesive layer 7, which is covered on the side opposite the plastic film with a carrier material 8, for example, a part of a carrier material moving through a path. The carrier material 8 has an adhesive that is applied through a corresponding treatment, for example, a siliconization, so that the laser-inscribable film can be pulled from the carrier material 8 and can be adhered to a different support surface. If the film laminate is first cut or stamped into individual labels, placards, plates, etc., then these labels, placards, plates, etc., are individually detachable from the carrier material 8 and can be adhered to various objects in a simple manner.

With the assistance of a laser beam 1b, 1b, for example, from an electronic, follow-up YAG-laser, surface areas illustrated with letters or graphical characters 11a, 11b of the metallic layer 3 can be ablated through a corresponding selection of the power and operating time of the laser beam 1b, 1c, such that the second ablatable layer 4 is not also ablated. The ablated regions 11a, 11b appear in a color that is produced from the color of the metallization 4 with the color-filtering effect of the protective layer 2 and the translucent layer 6. The non-ablated regions appear in a color, which is produced from the color of the metallization 3 with the color-filter effect of the protective layer 2.

With the assistance of the laser beam 1a, 1d of the electronic, follow-up YAG-laser, paired, overlapping surface regions illustrated with letters or graphical characters of the metallic layers 3 and 4 are ablated, when the power and operating time of the laser beam 1a, 1d is correspondingly adjusted, or the laser beam 1a, 1d is guided twice over the corresponding regions 12a, 12b. The regions 12a, 12b appear, then, in a mixed coloration, which results by the color-filtering effect of the protective layer 2 and the translucent layer 6 from the color of the contrastive layer 5. With brighter, adequately transparent coloration of the protective layer 2 and translucent layer 6, the color impression of a darkly colored contrast layer 5 is only minimally affected or not affected at all.

In the event of a yellow, dyed-through protective layer 2, a translucent layer 6 in a bright cyan, dyed-through translucent layer, silver white metallization 3, 4, and a black contrastive layer 5, green-metallic colored and black characters with a gold-colored background are produced. In the case of a bright cyan, dyed-through protective layer, a yellow, dyed-through translucent layer 6, silver white metallization 3, 4, and a black contrastive layer 6, green-metallic colored and black characters with a cyan-metallic colored background are produced.

1. A film that is inscribable by a laser beam (1a, 1b, 1c, 1d), which has at least one protective layer (2) that is substantially penetrable by the laser beam (1a, 1b, 1c, 1d), wherein a medium that is changeable by the laser beam (1a, 1b, 1c, 1d) is arranged on an underside of the at least one protective layer,
wherein the medium that is changeable by the laser beam (1a, 1b, 1c, 1d) has at least one opaque layer (3) that is ablatable by the laser beam (1a, 1b, 1c, 1d) and at least one contrastive layer (5) that is substantially resistant to the laser beam (1a, 1b, 1c, 1d),
characterized in that,
at least one of the at least one protective layer (2) that is substantially penetrable by the laser beam (1a, 1b, 1c, 1d) is dyed through.

2. The foil that is inscribable by a laser beam (1a, 1b, 1c, 1d) according to claim 1, characterized in that the medium that is changeable by means of the laser beam (1a, 1b, 1c, 1d) has at least two opaque layers (3, 4) that are ablatable by the laser beam (1a, 1b, 1c, 1d), and wherein, between the layers (3, 4) that are ablatable by the laser beam (1a, 1b, 1c, 1d), a respective translucent, dyed-through layer (6) is arranged.

3. The foil that is inscribable by a laser beam (1a, 1b, 1c, 1d) according to one of the preceding claims, characterized in that at least one of the opaque layers (3, 4) that is ablatable by the laser beam (1a, 1b, 1c, 1d) is a predominately metallic layer.

4. The foil that is inscribable by a laser beam (1a, 1b, 1c, 1d) according to one of the preceding claims, characterized in that the metallic layers (3, 4) are aluminum layers.

5. The foil that is inscribable by a laser beam (1a, 1b, 1c, 1d) according to one of the preceding claims, characterized in that at least one of the opaque layers that is ablatable by the laser beam (1a, 1b, 1c, 1d) contains a metal oxide.

6. The foil that is inscribable by a laser beam (1a, 1b, 1c, 1d) according to one of the preceding claims, characterized in that the contrastive layer (5) includes multiple layers of different colors.

7. The foil that is inscribable by a laser beam (1a, 1b, 1c, 1d) according to one of the preceding claims, characterized in that the medium that is changeable by the laser beam (1a, 1b, 1c, 1d) has a self-adhering layer (7) disposed at least partially on an under side.

8. The foil that is inscribable by a laser beam (1a, 1b, 1c, 1d) according to claim 7, characterized in that the film is disposed on a carrier material (8), wherein adhesive of the self-adhering layer (7) is non-permanently adhered to said carrier material (8).

9. The foil that is inscribable by a laser beam (1a, 1b, 1c, 1d) according to one of the preceding claims, characterized in that the protective layer (2) has an adhesive layer on an upper side.

10. The foil that is inscribable by a laser beam (1a, 1b, 1c, 1d) according to one of the preceding claims, characterized in that the protective layer (2) is at least partially printed or lacquered.

11. The foil that is inscribable by a laser beam (1a, 1b, 1c, 1d) according to one of the preceding claims, characterized in that the film has stampings, wherein said stampings subdivide the film into individual surface regions.

12. The foil that is inscribable by a laser beam (1a, 1b, 1c, 1d) according to claim 11, characterized in that at least individual signal surface regions formed by the stampings are at least partially detachable.

13. The foil that is inscribable by a laser beam (1a, 1b, 1c, 1d) according to one of the preceding claims, characterized in that the film is mountable on a support surface and additionally, has safety stampings, wherein said safety stampings make impossible undesired detachment of the film from the support surface without at least partial destruction of the film.

14. The foil that is inscribable by a laser beam (1a, 1b, 1c, 1d) according to one of the preceding claims, characterized in that the film is subdivided into individual, at least partially detachable surface regions by operation of the laser beam (1a, 1b, 1c, 1d) or a further laser beam.
